(19) United States
(12) Patent Application Publication
(10) Pub. No.: US 2015/0279234 A1
(43) Pub. Date: Oct. 1, 2015

(54) SYSTEM AND METHOD FOR COORDINATING A MEAL PLAN

(71) Applicant: Meal Garden Inc., Toronto (CA)

(72) Inventor: Volodimir CHERNENKO, Toronto (CA)

(73) Assignee: Meal Garden Inc., Toronto (CA)

(21) Appl. No.: 14/231,945

(22) Filed: Apr. 1, 2014

(51) Int. Cl. G09B 19/00; G09B 5/00

(52) U.S. Cl. CPC G09B 19/0092; G09B 5/00

(57) ABSTRACT

Disclosed is a method of coordinating a meal plan for a subject, the meal plan comprising a schedule of meals for predetermined meal times over a period of time, the method comprising: receiving an availability schedule comprising an indication of availability to prepare meals during the predetermined meal times over the period of time; receiving one or more food restrictions; and, generating the meal plan for the period of time based on the availability schedule and the one or more food restrictions.

### FIELD

The present disclosure relates to food services and in particular to a method of coordinating a meal plan for an individual or for a group of individuals.

### BACKGROUND

Individuals and families are often too busy to adequately plan for meals for an upcoming period of time. For example, a family may be too busy or otherwise not prepared to coordinate a schedule of meals or a meal plan for the upcoming week.

Coordinating a meal plan for a period of time may also be complex. Many factors may have to be considered when devising a meal plan such as levels of nutrition, availability of food and ingredients, scheduling availability of the subject or subjects, etc.

### BRIEF DESCRIPTION OF THE DRAWINGS

Reference will now be made, by way of example, to the accompanying drawings which show example embodiments of the present application and in which:

FIG. 1 is a block diagram illustrating a communication network;

FIG. 2 is a block diagram illustrating components of an electronic device;

FIG. 3 is a block diagram illustrating components of a meal planning system;

FIG. 4 is a schematic diagram illustrating a display of a meal planning application;

FIG. 5 is a flowchart depicting a method of coordinating a meal plan; and

FIG. 6 is a flowchart depicting another embodiment of a method of coordinating a meal plan.

Like reference numerals are used in the drawings to denote like elements and features.

### DETAILED DESCRIPTION

Described is a method of coordinating a meal plan for a subject, the meal plan comprising a schedule of meals for predetermined meal times over a period of time, the method comprising: receiving an availability schedule comprising an indication of availability to prepare meals during the predetermined meal times over the period of time; receiving one or more food restrictions; and, generating the meal plan for the period of time based on the availability schedule and the one or more food restrictions.

Also described is a system for coordinating a meal plan for a subject, the meal plan comprising a schedule of meals for predetermined meal times over a period of time, the system comprising: a database; a memory for storing instructions; a processor for executing instructions stored on memory, the processor associated with the database and the memory, the processor configured to: receiving an availability schedule comprising an indication of availability to prepare meals during the predetermined meal times over the period of time; receiving one or more food restrictions; and, generating the meal plan for the period of time based on the availability schedule and the one or more food restrictions.

Generally described are systems and methods for automatically generating and coordinating a plan for meals to be consumed over a set period of time by an individual, family or group of individuals. For example, the plan could be to provide food for a family of four individuals or a single individual. In accordance with an embodiment, the family provides the system with its schedule for the upcoming time period (the upcoming week, for example) and optionally with its nutritional or food restrictions. The schedule can include information such as when the family will be available to cook a meal, when the family or specific members of the family will be unable to eat at its residence, specific restaurants that the family will be attending for specific meals, as well as a preference of meal providers (e.g. restaurants). A meal plan for the family or individual will then be generated by the system and provided to that family or individual. The family or individual can then be given the opportunity to confirm of change the meal plan. The calculations and processing that are performed to create or generate the meal plan may be undertaken at a central server. The generated meal plan can be transmitted over the Internet to an electronic device used by the family or individual.

### Network Infrastructure

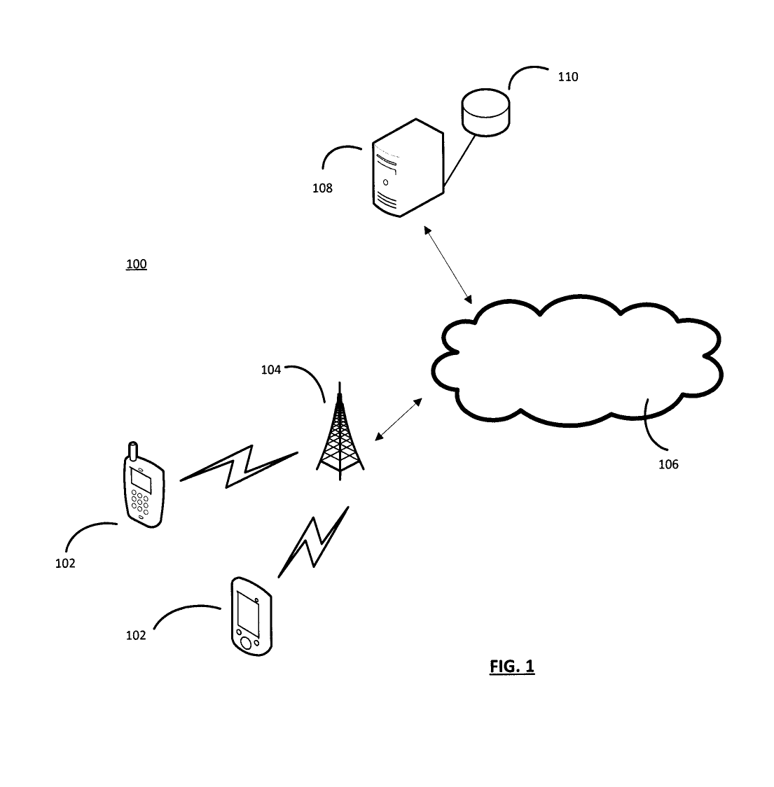

For convenience, like numerals in the description refer to like structures in the drawings. Referring to FIG. 1, a typical telecommunication infrastructure is illustrated generally by numeral 100. The telecommunication infrastructure 100 includes one or more electronic devices 102, one or more base stations 104, a communication network 106 and one or more network servers 108.

The electronic devices 102 include wireless computing devices such as a smart phone, a personal digital assistant (PDA), and the like. The electronic devices 102 are in communication with one of the base stations 104. The base stations relay data between the electronic devices 102 and the network servers 108 via the communication network 106. Accordingly, the communication network 106 may include several components such as a wireless network, a relay, a corporate server or a mobile data server for relaying data between the base stations 104 and the network servers 108.

The network server 108 can be a server such as a Web server, an application server 108, and an application server with web services. It will be appreciated by a person of ordinary skill in the art that the telecommunication infrastructure 100 described herein is exemplary and that changes may be made to one or more components to accommodate different network configurations without affecting the scope of the aspects described herein.

### Electronic Device

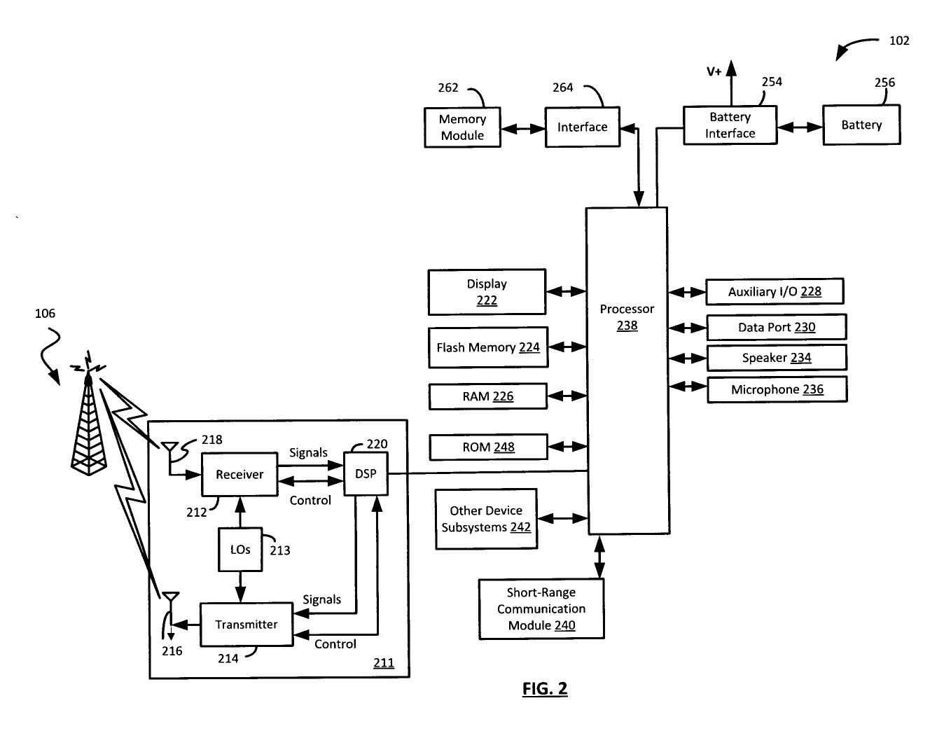

Referring to FIG. 2, a typical electronic device 102 is illustrated in greater detail. The electronic device 102 is often a two-way electronic device having both voice and data communication capabilities, including the capability to communicate with other computer systems. Depending on the functionality provided by the electronic device 102, it may be referred to as a data messaging device, a two-way pager, a cellular telephone with data messaging capabilities, a wireless Internet appliance, a smartphone, a table computer, or a data electronic device.

The electronic device 102 includes a communication subsystem 211, which includes a receiver 212, a transmitter 214, and associated components, such as one or more embedded or internal antenna elements 216 and 218, local oscillators (LOs) 213, and a processing module such as a digital signal processor (DSP) 220. As will be apparent to those skilled in field of communications, the particular design of the communication subsystem 211 depends on the communication network in which the electronic device 102 is intended to operate.

The electronic device 102 includes a processor 238, which controls general operation of the electronic device 102. The processor 238 can interact with additional device subsystems such as a display 222, a flash memory 224, a random access memory (RAM) 226, a read only memory (ROM) 248, auxiliary input/output (I/O) subsystems 228 (such as a keyboard or trackball, for example), a data port 230, a speaker 234, a microphone 236, a short-range communications subsystem 240 such as Bluetooth™ for example, and any other device subsystems or peripheral devices generally designated at 242.

Operating system software used by the processor 238 may be stored in a persistent store such as the flash memory 224 (which may be a ROM), a ROM 248 or similar storage element (not shown). The operating system, specific device applications, or parts thereof, may be temporarily loaded into a volatile store such as RAM 226.

The processor 238, in addition to its operating system functions, enables execution of software applications on the electronic device 102. A predetermined set of applications, which control basic device operations, is installed on the electronic device 102 during its manufacture. These basic operations typically include data and voice communication applications, for example. Additionally, applications may also be loaded onto the electronic device 102 through the network 106, an auxiliary I/O subsystem 228, serial port 230, short-range communications module 240, or any other suitable subsystem 242, and installed by a user in RAM 226, ROM 248 or flash memory 224, for execution by the processor 238. Such flexibility in application installation increases the functionality of the electronic device 102 and may provide enhanced on-device features, communication-related features, or both.

The short range communication module 240 provides for communication between the electronic device 102 and different systems or devices, which need not necessarily be similar devices. For example, the short range communication module 240 may include an infrared device and associated circuits and components, or a wireless bus protocol compliant communication mechanism such as a Bluetooth® communication module to provide for communication with similarly-enabled systems and devices.

The display 222 is used to visually present an application's graphical user interface (GUI) to the user. The user can manipulate application data by modifying information on the GUI using an auxiliary input/output device 228, such as a keyboard for example. Depending on the type of electronic device 102, the user may have access to other types of input devices, such as, for example, a scroll wheel, trackball, light pen or touch sensitive screen.

In some example embodiments, the auxiliary input/output (I/O) subsystems 228 may include an external communication link or interface, for example, an Ethernet connection. The electronic device 102 may include other wireless communication interfaces for communicating with other types of wireless networks; for example, a wireless network such as an orthogonal frequency division multiplexed (OFDM) network.

In some example embodiments, the electronic device 102 also includes a removable memory module 262 (typically including flash memory) and a memory module interface 264. Network access may be associated with a subscriber or user of the electronic device 102 via the memory module 262, which may be a Subscriber Identity Module (SIM) card for use in a GSM network or other type of memory module for use in the relevant wireless network type. The memory module 262 may be inserted in or connected to the memory module interface 264 of the electronic device 102.

In some example embodiments, the electronic device 102 is provided with a service routing application programming interface (API) which provides an application with the ability to route traffic through a serial data (i.e., USB) or Bluetooth® (Bluetooth® is a registered trademark of Bluetooth SIG, Inc.) connection to the host computer system using standard connectivity protocols. When a user connects their electronic device 102 to the host computer system via a USB cable or Bluetooth® connection, traffic that was destined for the wireless network 101 is automatically routed to the electronic device 102 using the USB cable or Bluetooth® connection. Similarly, any traffic destined for the wireless network 101 is automatically sent over the USB cable Bluetooth® connection to the host computer for processing.

The electronic device 102 also includes a battery 256 as a power source, which is typically one or more rechargeable batteries that may be charged, for example, through charging circuitry coupled to a battery interface 254 such as the serial data port 230. The battery 256 provides electrical power to at least some of the electrical circuitry in the electronic device 102, and the battery interface 254 provides a mechanical and electrical connection for the battery 256. The battery interface 254 is coupled to a regulator (not shown) which provides power V+ to the circuitry of the electronic device 102.

### Exemplary Meal Planning System

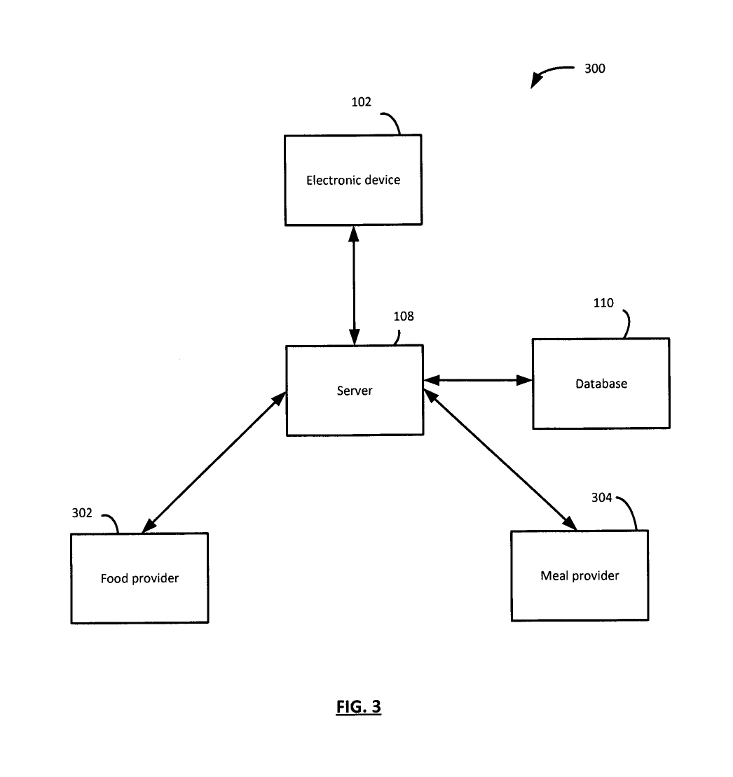

FIG. 3 shows a schematic design of an exemplary meal planning system 300. The depicted embodiment includes a server 108, an electronic device 102, a database 110, a meal provider 304, and a food provider 302. There are communication paths directly connecting the server 108 with each of the database 110, the electronic device 102, the food provider 302, and the meal provider 304. The communication paths can include a network 106 (such as the Internet, a local area network, etc.) or a direct link so that data can be passed over the network or directly between components connected by a communication path. An example of a direct link may be the communication path between the database 110 and the server 108: the database 110 may be in constant and direct communication with the server 108 through a dedicated line; or the database 110 may be integral with the server 108. Although only one electronic device 108, one meal provider 304 and one food provider 302 are shown in FIG. 3, there may be a plurality of each. In alternative embodiments, there may be no food provider 302 or no meal provider 304 or neither of both.

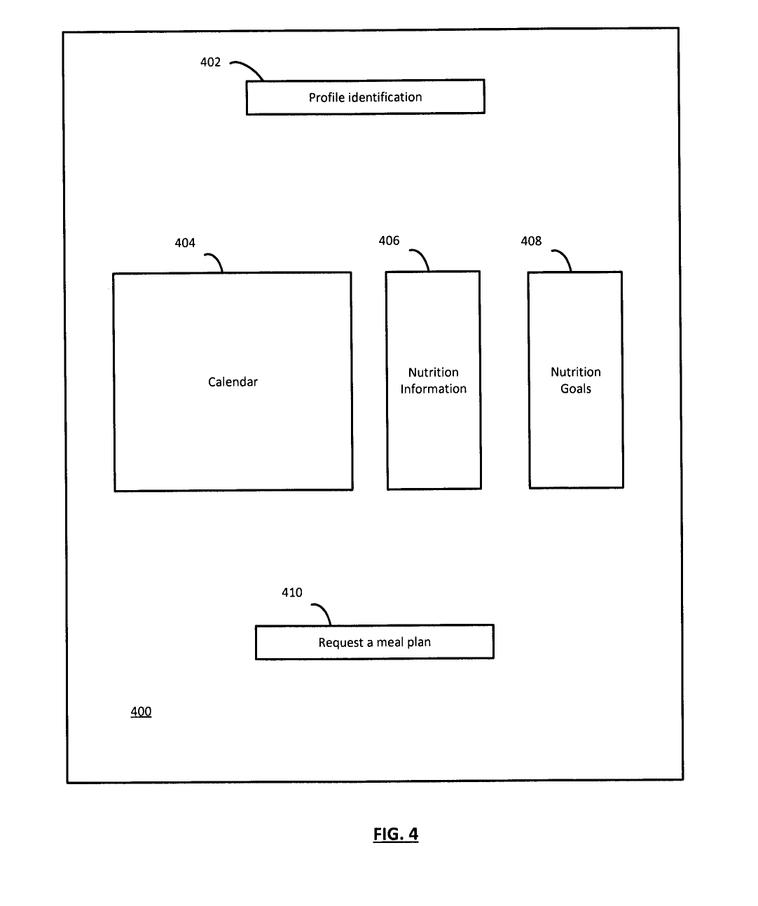

The electronic device 102 can be the electronic device 102 as described in relation to FIG. 2. A meal planning application may be downloaded onto the electronic device 102 (e.g. over the network 106 from the server 108). After the meal planning application is downloaded onto the electronic device 102 it can be used to access certain features of the meal planning system and to initiate the coordination of the meal plan. Similarly, information or data can be input into the meal planning application to be transmitted to or accessed by the server in order to tailor the coordination of the meal plan. Other data may be provided using the meal planning application so that such data can be stored in the database 110, for example. The meal planning application is descried in more detail in relation to FIG. 4.

The server 108 can receive information from the electronic device 102 through the meal planning application. For example, data may be entered into the meal planning application by a user of the electronic device 102 and that data may then be sent to the server 108 for further processing. Such data may be used in the coordination of a meal plan or such data may be stored in the database 110 as part of a profile (e.g. profile data) for the user. Each user or subject may have a profile for the meal planning system. The profile can include profile data.

The database 110 may include profile data and schedule data for families or individuals or other entities (i.e. subjects) who use the meal planning system. For example, a subject (e.g. a family, an individual or organization) may register with the meal planning system using the meal planning application downloaded on an electronic device 102. This registration may include providing information such as an address and optionally nutritional or food restrictions. Nutritional or food restrictions can include allergies or food that cannot be ingested due to medical reasons. The registration may include indication (e.g. through a mouse click, button selection etc.) on a display screen of the electronic device 102 that the user is requesting to register with the meal planning system. After the registration is complete a profile is be created and stored in the database 110. The profile can include information such as the name of the user, the address associated with the user, one or more nutritional or food restrictions. The profile can also include past meal schedules, and availability schedules for upcoming time periods. The profile can also include preferred meal providers 304 or preferred food providers 302. The one or more profiles that are stored in the database 110 can be accessed and altered by the server 108.

The server 108 can receive a request from the electronic device 102 to coordinate a meal plan. The request can be input at the electronic device 102 using the meal planning application. For example, the electronic device 102 may receive input through an input interface. The request transmitted from the electronic device 102 to the server 108 includes an identification of the subject or user (e.g. the family, individual, etc.) associated with a profile for which the meal plan is to be implemented or coordinated. The request can include an identification of the period of time over which the meal plan is to be implemented or coordinated. The request may also include one or more nutritional or food restrictions associated with the profile. In response to the request the server 108 can access or retrieve profile data associated with the subject that made the request.

The server 108 can also receive an availability schedule associated with the user or subject from the electronic device 102. The availability schedule received from the electronic device 102 is the schedule of availability for the subject associated with the request. For example, the availability schedule may include an indication of the availability to prepare meals during predetermined meal times over a specified period of time. By way of further example, the availability schedule can include an indication of the how many individuals (e.g. if the subject is a family or group of individuals) will be available to consume a meal during each of the predetermined meal times over the period of time.

The server 108 takes as input data provided through the meal planning application and data retrieved from the database 110 and generates a meal plan for the period of time based on the availability schedule and one or more food restrictions. For example, the server 108 receives the identification of the subject, a period of time, and the availability schedule from the electronic device and a selection of food restrictions from the database 110 and generates one or more meal plans for the subject. The meal plan can include a schedule of meals for each of the predetermined meal times over the period of time. The server 108 can be configured to create a meal plan that accords with a predetermined nutrition guideline so that all of the meals suggested to be consumed throughout the course of the period of time are within the nutrition guidelines.

The generated meal plan can include schedule of meals for the specific period of time. For example, if the period of time is one week, the meal plan will include a schedule of specific meals of each of the three meals of each day of the week. The meal plan will account for the number of individuals associated with the subject which requested the meal plan. For example, the meal plan will schedule meals of all individuals associated with the profile for that subject. It is understood that the meal plan can be for a period other than one week.

The generated meal plan may also include one or more recipes, which may be stored in and retrieved from the database 110. For example, one or more recipes can be stored in the database 110. The recipes include the ingredients and instructions required to make a particular meal. The recipes may also include nutrition information for the respective meal.

The generated meal plan may also include a grocery list that lists the ingredients required for the one or more recipe. The grocery list may be transmitted to the electronic device 102 associated with the subject and thereafter may be editable or confirmed by the subject and transmitted back to the server 108 to be stored in the database 110. The database 110 may also store an identification of an electronic device 102 in a subject's profile.

The generated meal plan can also schedule one or more meal at a restaurant (or meal provider) based on whether or not the provided availability schedule indicates that one or more individual associated with the profile or subject are available to cook or prepare such one or more meals. Similarly, the generated meal plan can also schedule one or more meal to be delivered from a restaurant or meal provider based on whether or not the provided availability schedule indicates that the one or more individuals associated with the profile are available to cook or prepare such one or more meals. In other words, if now one is available to cook or prepare a meal and if one or more individuals associated with the subject requires a meal for a specific meal time, then the generated meal plan will schedule a delivery of a meal from a restaurant for that meal time.

The generated meal plan can be transmitted to the electronic device 102 to be accessible from and displayed using the meal plan application. The generated meal plan can also be stored in the database 110 for updating or later retrieval. The generated meal plan may then be stored in the database in association with the profile for the subject for which the meal plan was generated.

In one or more embodiments, the generated meal plan can be edited or confirmed or agreed upon through an input to the meal plan application at the electronic device 102. The meal plan application may be password protected (e.g. a password and login may be required to access the meal plan application on an electronic device 102). The same profile and generated meal plan may be accessible from multiple electronic devices 102 by identifying the subject associated with the profile for example.

In accordance with the depicted embodiment, the server 108 is also in communication with one or more food provider 302 (although only one is pictured in FIG. 3). For example, there may be an electronic device 102 associated with the food provider 302 that the server 108 communicates with. The server 108 may transmit one or more requests to the food provider to gather ingredients for the list of groceries associated with the generated meal plan. The server 108 may also transmit one or more requests to the food provider to deliver ingredients for the list of groceries associated with the generated meal plan to a specified address. The address can be an address associated with the profile of the subject (e.g. stored in the database 110 with the profile data for that subject). A food provider 302 can be a grocery store, a farmer, a farmer's cooperative, a specialty food store, or any other organization that sells or provides ingredients for food or ingredients for cooking.

In one or more embodiments, there are multiple food providers 302 (although only one is pictured in FIG. 3). The profile data may include a preference of food providers 302 and the database 110 may include a list of available ingredients at each food provider 302. The server 108 can consider each of these factors when generating the meal plan. A grocery list for all of the ingredients identified in the recipes for the period of time may be prepared as part of the generated meal plan. In an embodiment, the entire grocery list is transmitted to a food provider 302 before the period of time (or at the beginning of the period of time). In another embodiment, the grocery list is divided into more than one grocery list that is each transmitted to a food provider 302.

The server 108 is also in communication with one or more meal providers 304 (although only one is pictured in FIG. 3). A meal provider 304 can be any entity or organizations that can provide food or prepared meals for delivery, pick up or consumption. For example, a meal provider 304 can be a restaurant that delivers prepared meals on demand to a provided address. By way of further example, the meal provider 204 may be an organization that itself contacts restaurants and then coordinates the delivery of prepared meals from such a restaurant to a provided address.

The server 108 may be configured to transmit meal requests to one or more meal provider 304. For example, the server 108 can transmit an order for a specific meal to a meal provider 304. The order can be for a specific meal to be provided to an address associated with a profile for who the meal plan was generated at a specific time (i.e. for a specific meal time). Such an order will be in accordance with the provided availability schedule will be based on the generated meal plan. For example, if the availability schedule indicates that the subject or individuals identified in the subject will not be able to prepare a certain meal at a certain time, then the generated meal plan may include an indication that such a meal will be provided by a meal provider 304.

In one or more embodiments, the server 108 may require a confirmation from the subject (e.g. through the meal plan application on the electronic device 102) before transmitting an order to a meal provider 304. For example, the server 108 may require a confirmation for each particular order schedule to be transmitted to a meal provider 304. In an alternative example, the server 108 may require only a confirmation of the entire generated meal plan. By way of further example, the subject can be provided with an opportunity to amend the meal plan, such as by replacing a meal or recipe with another one or by changing the meal provider 304 for a specific meal or by changing food provider 302.

In one or more embodiments, the server 108 may automatically determine which meal providers 304 to contact to request delivery of the prepared meals in accordance with the generated meal plan. The selection of the meal provider may be based on one or more of a number of criteria, which include for example the location of the meal provider 304 and the menu of meals available from the meal provider 304. The selection of a meal provider 304 for a particular meal may also depend on preferences associated with the subject's profile in the database 110.

In one or more example, a user or subject may provide preferences to the server 108 through the meal planning application. The preferences can then be stored in the database 110 (e.g. by the sever 108) in association with the subject's profile. The preferences can be preferred meal providers 304 or preferred food providers 302. For example, the preferences may consist of a list of preferred restaurants or a list of preferred grocery stores, each of which may be listed in preferential order.

In one or more embodiments, the server 108 may evaluate each meal provider 304 in the database 110 that have an address within a specific geographic range of the address associated with a subject's profile in order to determine from which meal provider to request the delivery of a prepared meal for the generated meal plan for that subject. This can be in order to generate the meal plan. For example, the server 108 may have access to a map and a profile may include geographical restrictions such as a maximum distance within which a food provider 302 or meal provider 304 must reside in order to be utilized in the generated meal plan.

In one or more embodiments, the meal provider 304 may register with the meal planning system. For example, the meal provider 304 can register by providing certain information to the server 108, which can then be stored in the database 110 in association with the meal provider's 304 identification or profile. Such information can comprise the profile data of the meal provider 304 and may include the name of identification of the meal provider 304, the menu of meals offered by the meal provider 304 (including nutrition information and ingredients for each meal listed on the menu), and one or more addresses associated with the meal provider 304 (e.g. the location(s) of where the meals can be delivered from or picked up from). The meal provider 304 may also supply other information to the server 108 to be stored in the database 110 in association with the meal provider's 304 profile such as the availability of specific meals on specific days, whether the meal provider 304 delivers meals within a specified geographic region. The information stored in the database in association with the meal provider's 304 profile (e.g. as part of the meal provider's 304 profile data) can be used as a basis for generating the meal plan for a subscriber.

The server 108 is configured to generate a meal plan for the user profile associated with the electronic device 102 for a specific period of time provided through the meal planning application. The meal plan is generated based on the availability schedule associated with the subject's profile (e.g. provided by the electronic device 102), on the meal providers 304, on the food providers 302, and on any other data associated with the subject's profile.

The server 108 may also generate nutrition information associated with the generated meal plan. The server 108 may calculate all of the nutrition information in each of the meals planned for the entire time period and present the total nutrition information to the user through the meal planning application. The server 108 may also periodically update the nutrition information for meals that have already been consumed during the period of time. For example, the server 108 may transmit nutrition information to the electronic device 102 upon receiving a request to provide such nutrition information.

The nutrition information may have been stored in the database 110 in association with each meal from each meal provider 304 and with each recipe stored in the database.

The server 108 may also be configured to dynamically update the generated meal plan. For example, data can be provided from the subject (e.g. through the meal plan application) during the period of time for which a meal plan was generated. For example an updated availability schedule can be provided to the server 108. This data can be used to alter or update the generated meal plan for one or more of the remaining predefined meal times over the period of time. By way of further example, the meal plan may be regenerated to coordinate the meal plans for the remainder of the meals in the period of time for the subject in order to take into account the new data.

### Exemplary Meal Planning Application

FIG. 4 is a schematic diagram of an embodiment of a display of a page 400 of a meal planning application 400. The meal planning application can operate on the electronic device 102. For example, the meal planning application can be displayed on the display 222 of the electronic device 102 and may be responsive to inputs received at the electronic device 102. FIG. 4 shows the display 222 on which a page 400 or view of the meal planning application is presented. For example, it may be the home page 400 of the meal planning application that is shown in FIG. 4.

In accordance with one or more embodiments, a display of a home page 400 of a meal application on an electronic device 102 can include a number of different display areas, such as a profile identification section 402, a calendar 404, nutrition information 406 for a generated meal plan, nutrition goals 408 for the time period under consideration, and a button 410 for requesting a meal plan. The time period under consideration is the time period for which a meal plan has been or will be generated.

The home page 400 shown in FIG. 4 may display information related to a specific profile stored in the database 110. The server 108 may periodically synchronize profile and related information between the database 110 and the electronic device 102 in order to display such information through the meal planning application.

The profile identification section 402 indicates the identification of a profile. For example, it may be a profile that is associated with a subject who has logged onto the meal planning application. In other words, the meal planning application may be configured to receive login information for a particular subject. The login information may be transmitted to the server 108 and verified at the server 108. After the login information is verified the information or data for that subject can be synchronized with the meal planning application so that profile data from the subject's profile is displayed on the display page 400. The profile is one that is registered with the meal planning system and that may be stored in the database 108.

In one or more embodiments, a login page may be presented on the display. Login information can be input into the login page and is then transmitted to the server 108. The login information may be associated with a profile (e.g. profile data) stored in the database 110. The server 108 can then synchronize the profile stored in the database 110 with the profile identification (and other profile data) accessible through and displayed on the page 400 of the meal planning application on the electronic device 102. For example, the synchronization of the profile data with the electronic device 102 can amount to transmitting the profile data from the database 110 to the electronic device 102 where it can be stored on memory (e.g. RAM 226) for access by the meal planning application.

The calendar 404 can be configured to display the meal plan for the subject for a period of time. For example, the calendar 404 may display the titles of meals planned for the present week regardless of the period of time associated with the meal plan in a typical calendar format. In one or more embodiments, the calendar 404 section of the page 400 can be configured by input. For example, the particular days displayed on the calendar may be selected by an input mechanism (e.g. the next week can be displayed using a specific input, or the next month, etc.). The days shown in the calendar 404 can be selectable using an input device in order to view more detailed information. For example, a selected day can be shown in a pop-up window on the display 222. Similarly, the titles of the meals planned for a time period (if they are displayed in the calendar 404) may be selectable using an input device in order to provide more details (e.g. in a pop-up window on the display 222) such as the ingredients in the meal or the nutrition content in the meal.

In one or more embodiments, when a date or day in the calendar 404 section of the display is selected the meals or recipes for the meals for that date appear, if available (i.e. if a meal plan has been generated). Similarly, if a meal title is displayed in the calendar 404 and the meal title is selected, information about that meal may be displayed in a new window. Information about a meal can include a recipe or the identity and location of the meal provider 304. The calendar 404 may be populated with meal planning information after a meal plan is generated and transmitted from the server 108 to the electronic device 102 (e.g. synchronized). The meal information may then be stored in a memory 224, 226 associated with the electronic device 102 or it may be accessed from the database 102 on demand after a meal or day is selected from the calendar 404 section of the displayed 400 meal planning application.

The nutrition information 406 section of the display 400 shows the nutrition information for a specific meal or for a specific generated meal plan. For example, the meal plan for which nutrition information is shown in the nutrition information 406 section may have been generated at the server 108 and transmitted to or synchronized with the electronic device 102. By way of further example, the nutrition information section 406 can display nutrition information for a meal or a day that was selected (e.g. using an input mechanism such as a touch on a touchscreen or an activation button) from the calendar section 404. For example, there may be an option (e.g. selectable components, or selectable buttons) associated with the calendar 404 or with the nutrition information section 406 which can receive input requesting the display of certain nutrition information. If a specific meal is selected in the calendar 404, then the nutrition information associated with the selected meal (e.g. from the meal plan) can be displayed in the nutrition information section 406. Similarly, if a generated meal plan is displayed in the calendar 404 then the nutrition information for the generated meal plan may be displayed in the nutrition information section 406. Alternatively, the nutrition information for the consumed meals in a generated meal plan may be displayed in the nutrition information 406 section.

Nutrition information displayed in the nutrition information section 406 can include the quantity of calories in a meal (or in a generated meal plan in total) and the breakdown or listing of ingredients in a meal, for example. In one or more embodiments, the nutrition information can include the percentage of recommended daily intake of various vitamins, minerals and other components as suggested by a food guide, such as the Canadian Food Guide

The nutrition goals section 408 of the page 400 can display nutritional goals associated with the profile or with a generated meal plan. For example, nutritional goals may be submitted to the server 108 through the meal planning application. For example, there may be an option (not shown) on the interface of the meal planning application that allows nutritional goals to be entered and transmitted to the server 108. Examples of nutritional goals for a user would include calorie intake restrictions, macro-nutrient balance, vitamin/mineral intake requirements, and adherence to a certain diet.

The page 400 for the meal planning application also includes a meal plan button 410. The meal plan button 410 can be selected using an input mechanism in order to request the server 108 to generate a meal plan. Upon selection of the meal plan button 410 a prompt may request certain information used to generate the meal plan. For example, the prompt may request the time period over which the meal plan is to be generated. The prompt may also request additional data such as an availability schedule indicating the availability of the subject to prepare meals. The prompt may also request a password for the subject (which had been previously determined).

In one or more embodiments, the availability schedule for the subject may be created or amended through a selection in the profile identification section 402 of the display. This availability schedule may be stored in a local memory and later synchronized (e.g. copied to) to profile (e.g. the profile data for that profile) in the database 110 or it may be directly stored in the database 110 by directly amending profile data. After the request a meal plan button 410 is selected the server 108 may automatically use the availability schedule created or amended through the profile identification 402.

### Exemplary Method of Coordinating a Meal Plan

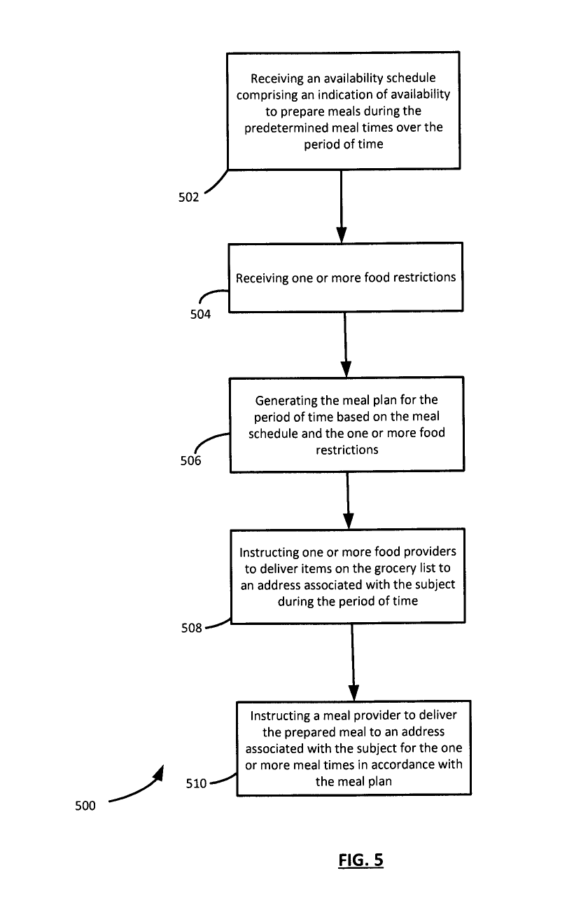

In accordance with an exemplary embodiment, FIG. 5 depicts a method 500 of coordinating a meal plan. The method 500 may be executed on processor that is associated with a memory on a server 108 or electronic device 102. For example, method 500 may be executed on the server 108 depicted in FIG. 3.

The meal plan that is coordinated can be a schedule of meals for predetermined meal times over a period of time. The predetermined meal times can be set by the server 108 and can be the three typical meals per day (breakfast, lunch, dinner). Other configurations of meal schedules can be coordinated. For example, the predetermined meal times may be altered for a specific user (e.g. the subject) or specific profile through the meal planning application. For example, a specific user associated with a profile may be able to select or set the predetermined meal times.

The schedule of meals can include the identification of meals to be consumed at each of the predetermined meal times over the period of time. The period of time can be selected by the subject. For example, the period of time can be one week, one month or three days or another reasonable period of time.

The subject can be an individual or plurality of people (e.g. a family or community). In accordance with one or more embodiments, the subject is associated with a profile (e.g. profile data) stored in the database 108.

With reference to the method 500 depicted in FIG. 5, at 502, an availability schedule comprising an indication of availability to prepare meals during the predetermined meal times over the period of time is received. The availability schedule may be provided by the subject using the meal planning application (e.g. the subject can provide the availability schedule through an interface). The availability schedule can include an indication for each predetermined meal time over the period of time whether the subject is available to prepare a meal or whether the subject requires a meal provider to provide a meal on its behalf. As noted the meal provider can be a meal delivery service or a restaurant, for example.

In one or more embodiments, the meal plan that is being coordinated includes recipes for one or more meals. For example, if the availability schedule indicates that the subject is available to prepare a meal for a specific predetermined meal time, then the meal plan may include a recipe for a meal for that specific predetermined meal time. Similarly, the meal plan may also include nutrition information.

At 504, one or more food restriction is received. The food restrictions can be provided by the subject through the meal planning application, for example. By way of further example, the food restrictions can be provided by the subject through an interface associated with the meal planning application. The food restrictions can then be stored in the database 110 in association with the profile for that subject. By way of further example, the food restrictions associated with the profile can be accessed from the database 110. In other words, the food restrictions may have been previously provided and stored in the database 110 for later use. Food restrictions can include dietary restrictions (e.g. food or ingredients that the subject will not consume), health restrictions (e.g. food or ingredients that the subject cannot consume due to health reasons), or nutritional restrictions (e.g. restrictions on types of vitamins or minerals or food groups), for example. Food restrictions can also include or identify acceptable maximum volumes or amounts of a food or ingredient over a time period (e.g. amount of sugar over any day).

In one or more embodiments, the subject consists of multiple individuals. For example, the subject can be a family or a group of individuals. A reference to “subject” in the present disclosure can be taken to mean all of the individuals included in the subject or it can be taken to mean a subset of the individuals included in the subject. For example, a generated meal plan can consider different meals for different individuals that are included in the subject for the same meal time.

At 506, the meal plan for the period of time is generated based on the availability schedule and the one or more food restrictions.

The generated meal plan can include one or more recipes. In one or more embodiments, generating the meal plan includes generating a grocery list of ingredients for use in the recipes. For example, the generated meal plan can include meals to be cooked or prepared at certain meal times in the predetermined time. In such an example the generated meal plan can include the recipe(s) or instructions for preparing or cooking the meal. Thus a generated meal plan can include multiple recipes (e.g. one for each meal to be cooked or prepared under the generated meal plan).

In one or more embodiments, a grocery list may be included with the generated meal plan. The grocery list can be generated using the ingredients required to cook or prepare the meal(s) identified in the generated meal plan that are not from a meal provider. The grocery list can be compiled from the ingredients required for each meal plan over a number of meals. For example, a grocery list may be generated which includes the ingredients for all meals to be prepared for the period of time for which the meal plan is generated.

At 508, one or more food provider is instructed to deliver items on the grocery list to an address associated with the subject during the period of time. A food provider 302 may be in communication with the server 108 over a network such as through a dedicated application on an electronic device 102 accessible by the food provider or through an electronic mail service, for example. In one or more embodiments, the grocery list is transmitted to the food provider 302 with instructions to deliver the items on the grocery list within a specific time period.

In one or more embodiments the generated meal plan includes scheduling a prepared meal for one or more meal time over the period of time. For example, a meal can be prepared by a meal provider 304, such as a restaurant or other food preparation service for the subject. In one or more embodiments, the meal provider 304 prepares one or more meals identified on the generated meal plan as requested by the server 108. The request from the server 108 may include an indication of when each meal is to be picked up or retrieved from the meal provider on behalf of the subject.

In one or more embodiments, the meal provider 304 is requested to deliver the prepared meal to the address associated with the subject around or at a specifically requested time.

At 510 a meal provider is instructed to deliver the prepared meal to an address associated with the subject for the one or more meal times in accordance with the meal plan.

The server 108 or database 110 can maintain a list of food providers 302 and meal providers 304 for future use. Each of the food providers 302 and meal providers 304 may be associated with an address in memory.

After the method 500 is completed, the generated meal plan may have an indication of either one or more recipe for a meal or a meal prepared by a meal provider for each predetermined meal time in the period of time.

In one or more embodiments, the food restrictions can include a preference of meal providers 304. Similarly, the food restrictions can include a preference of food providers 302. Such food restrictions, which can be stored in the database 110 in associated with the subject's profile can be used to determine the identity of the food provider 302 or meal provider 304 to use to deliver or prepare ingredients or meals for the subject as part of the meal plan. For example, the meal provider 304 can be selected based on the preference of meal providers 304. Similarly, the food provider 302 can be selected based on the preference of food providers 302.

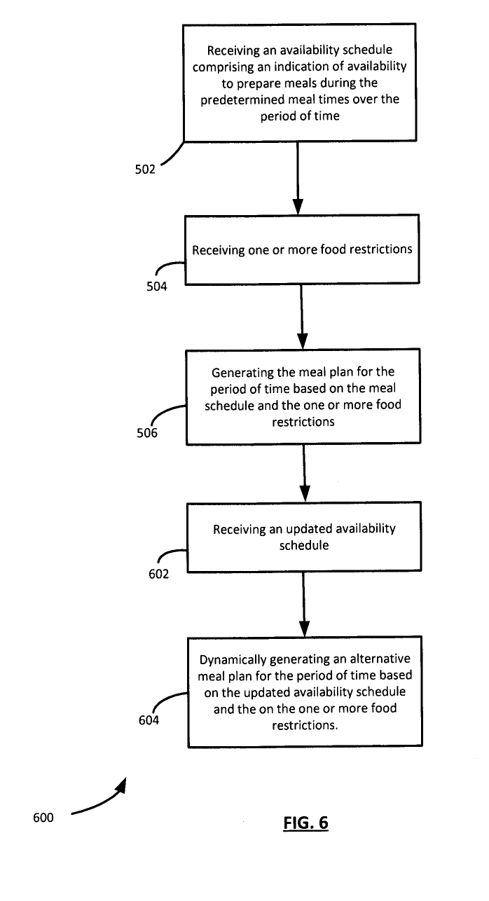

FIG. 6 depicts another embodiment of a method 600 of coordinating a meal plan for a subject. Such a method may also be executed on the server 110. The method 600 considers changing the generated meal plan part way through the period of time.

Steps 502, 504 and 506 are carried out as per the method 500 described in respect of FIG. 5. After step 506 the meal plan will have been generated.

At 602 an updated availability schedule is received. The updated availability schedule can include an indication of whether the subject will be available to prepare a meal at one or more of the meal times. The updated availability schedule may be used to replace at least part of an availability schedule that was received at 502. The updated availability schedule can be stored in the database 110 in association with the profile for the subject.

At 604, an alternative meal plan for the period of time is dynamically generated based on the updated availability schedule and on the one or more food restrictions. The alternative meal plan can include the meal plan for the remaining predetermined meal times in the period of time.

An example of an algorithm that can be used or implemented (e.g. at the server) to generate a meal plan may be as follows:

For Each Day in the Meal Plan that Requires Cooking:
1. Iterate through recipes (e.g. which are stored in memory), pick a main dish that:
   satisfies the subject's preferences the most (e.g. that satisfies the subject's availability schedule the most);
   stays within the subject's nutritional restrictions;
   is the closest to satisfying nutritional balance requirements (which may be part of the subject's profile, for example, or which may be provided by the subject or which may be provided by a third party, such as from the Canada Food Guide); and
   was not offered within last N days, unless there is no other available recipes (where N may be a predetermined number, which can be set by an administrator or by the subject for example);
2. Iterate through the rest of the recipes pick a side/salad/etc. dish that
   satisfies the subject's preferences the most;
   combined with the already selected dish (from 1) stays within the subject's nutritional restrictions;
   combined with already selected dish (from 1) is the closest to satisfying nutritional balance requirements; and
   was not offered within last N days, unless there is no other available recipes.
3. Repeat step 2 until nutritional requirements (e.g. nutritional balance requirements) are satisfied.

For Each Day that Requires Take-Out or Delivery:
1. Iterate through meal providers that provide delivery/take-out within specified parameters and pick a restaurant that:
   satisfies the subject's preferences the most; and
   was not offered within last N days, unless there is no other availability (e.g. unless there is no other available restaurant).
2. Iterate through selected meal provider dishes (e.g. the meals offered by or from the meal provider), pick a main dish that:
   satisfies the subject's preferences the most;
   stays within nutritional restrictions of the subject (e.g. as provided in the subject's profile or as provided by the subject);
   is the closest to satisfying nutritional balance requirements (which may be part of the subject's profile, for example, or which may be provided by the subject or which may be provided by a third party, such as from the Canada Food Guide); and
   was not offered within last N days, unless there is no other available dishes (again, N may be predetermined).
3. Iterate through the rest of the meal provider dishes pick a side/salad/etc. dish that:
   satisfies the subject's preferences the most;
   combined with already selected dish stays within nutritional restrictions of the subject;
   combined with already selected dish is the closest to satisfying nutritional balance requirements; and
   was not offered within last N days, unless there is no other availability.
4. Repeat step 3 until nutritional requirements are satisfied.

The above noted steps in an algorithm can be carried out (e.g. executed) at the server 108 for example.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is the following:

1. A method of coordinating a meal plan for a subject, the meal plan comprising a schedule of meals for predetermined meal times over a period of time, the method comprising:
receiving an availability schedule comprising an indication of availability to prepare meals during the predetermined meal times over the period of time;
receiving one or more food restrictions; and,
generating the meal plan for the period of time based on the availability schedule and the one or more food restrictions.

2. The method of claim 1 wherein the meal plan further comprises recipes for one or more meals, and wherein the recipes are for the meal times during which the availability schedule indicates an availability to prepare meals.

3. The method of claim 2 wherein generating the meal plan further comprises generating a grocery list of ingredients for use in the recipes.

4. The method of claim 3 further comprising instructing one or more food providers to deliver items on the grocery list to an address associated with the subject during the period of time.

5. The method of claim 1 wherein the meal plan further comprises scheduling a prepared meal for one or more meal times over the period of time.

6. The method of claim 5 further comprising instructing a meal provider to deliver the prepared meal to an address associated with the subject for the one or more meal times in accordance with the meal plan.

7. The method of claim 6 wherein the food restrictions comprise a preference of meal providers, the method further comprising selecting the meal provider based on the preference of meal providers.

8. The method of claim 1 wherein the food restrictions comprise one or more of a dietary restriction and a nutritional restriction.

9. The method of claim 1 wherein the period of time comprises one week.

10. The method of claim 1 wherein the subject comprises a plurality of people.

11. The method of claim 1 further comprising compiling nutrition information from the generated meal plan.

12. The method of claim 1 further comprising:
receiving an updated availability schedule; and
dynamically generating an alternative meal plan for the period of time based on the updated availability schedule and the one or more food restrictions.

13. A system for coordinating a meal plan for a subject, the meal plan comprising a schedule of meals for predetermined meal times over a period of time, the system comprising:
a database;
a memory for storing instructions;
a processor for executing instructions stored on memory, the processor associated with the database and the memory, the processor configured to:
receiving an availability schedule comprising an indication of availability to prepare meals during the predetermined meal times over the period of time;
receiving one or more food restrictions; and,
generating the meal plan for the period of time based on the availability schedule and the one or more food restrictions.

14. The system of claim 13 wherein the meal plan further comprises recipes for one or more meals, and wherein the recipes are for the meal times during which the availability schedule indicates an availability to prepare meals.

15. The system of claim 14 wherein generating the meal plan further comprises generating a grocery list of ingredients for use in the recipes.

16. The system of claim 15, wherein the processor is further configured to instruct one or more food providers to deliver items on the grocery list to an address associated with the subject during the period of time.

17. The system of claim 13 wherein the meal plan further comprises scheduling a prepared meal for one or more meal times over the period of time.

18. The system of claim 17 wherein the processor is further configured to instruct a meal provider to deliver the prepared meal to an address associated with the subject for the one or more meal times in accordance with the meal plan.

19. The system of claim 18 wherein the food restrictions comprise a preference of meal providers, the method further comprising selecting the meal provider based on the preference of meal providers.

20. The system of claim 1 wherein the processor is further configured to:
receiving an updated availability schedule; and
dynamically generating an alternative meal plan for the period of time based on the updated availability schedule and the one or more food restrictions.
